(19) United States
(12) Patent Application Publication
(10) Pub. No.: US 2010/0082474 A1
(43) Pub. Date: Apr. 1, 2010

(54) Computer method and apparatus that facilitates the trading of complex financial instruments on the internet within the context of a portal as defined by the United States Securities and Exchange Commission

(76) Inventor: Perry Harley Beaumont, Ridgefield, CT (US)

Correspondence Address: PERRY H. BEAUMONT, 845 N. SALEM RD., RIDGEFIELD, CT, 06877, US

(21) Appl. No.: 12/583,777

(22) Filed: Aug. 26, 2009

Related U.S. Application Data
(60) Provisional application No. 61/190,166, filed on Aug. 26, 2008.

(51) Int. Cl. G06Q 40/00; G06F 15/16; H04L 12/66; H04L 12/16

(52) U.S. Cl. 705/37; 709/206; 370/352; 370/260

(57) ABSTRACT

Computer method and apparatus that facilitates the trading of complex financial instruments on the internet within the context of a portal as defined by the United States Securities and Exchange Commission.

Applicant claims the benefit of provisional application No. 61/190,166, filed on Aug. 26, 2008 and titled Computer method and apparatus that facilitates the trading of complex financial instruments on the internet within the context of a portal as defined by the United States Securities and Exchange Commission.

### BACKGROUND OF THE INVENTION

1. Field of Invention

Computer method and apparatus that facilitates the trading of complex financial instruments on the internet within the context of a portal as defined by the United States Securities and Exchange Commission.

2. Background

Currently more than one-half of all financial instruments that trade globally are transacted outside the context of an organized exchange. These so-called non-listed and over-the-counter, or OTC, securities can oftentimes be characterized as exotic and complex products. The complexity of the products may stem from a variety of factors. For example, the products may be complex because they are uniquely tailored investments specifically created for the investor and embodying a variety of multifaceted components, or a product may simply be considered complex because securities of its kind do not trade with any regularity and as such it is difficult to objectively determine its fair value.

When holders of a complex financial instrument determine that they no longer wish to be an investor in the security, they may oftentimes find themselves beholden to the particular financial institution that structured and issued the security to buy it back. If that particular issuing financial institution happens not to have an interest in procuring the complex financial instrument, the investor in that instrument may ultimately feel compelled to accept less than the instrument's true worth in order to rid themselves of the security. Potentially compounding this challenge of seeking to sell the security is any additional compensation the particular financial institution might demand if they were to purchase the financial instrument. This additional compensation might be claimed, for example, as being necessary to offset the illiquid nature of the complex security. Relative to more liquid, actively-traded securities, illiquid securities can be more expensive to hedge, to re-sell, to account for, and to manage.

Another challenge with the buying and selling of complex financial products is that many times there is a need for unique information pertaining to the securities, and in some cases the expression of interest for that information may be desired to be made discreetly. The need for discretion may be attributable to a number of considerations, as with a portfolio manager's not wanting to reveal the particular interests of their clients' investment profiles as this is oftentimes protected by federal and state statues as being of a private and confidential matter. Related to this matter of discretion, buyers and sellers of financial products of any type require trading venues that permit information to be protected, and especially when business is being conducted over the internet.

As an additional challenge associated with an auctioning of financial securities, there is the matter of determining what incremental bids should be for the auction process. Since the securities to be offered at the portal will be available exclusively to qualified institutional buyers, it is expected that the market values of these securities could be in excess of one-million U.S. dollars, or the equivalent of one-million U.S. dollars if the securities are denominated in non-U.S. dollar currencies. As such, it would be inconsistent for the site to arbitrarily impose a fixed U.S. dollar (or U.S. dollar equivalent) amount as a bidding increment. For example, if a fixed bid increment were imposed as being 10,000 U.S. dollars for all financial securities, this bidding increment would represent 1 percent of a one-million U.S. dollar market value. However, for a financial security having a ten-million U.S. dollar market value, 10,000 U.S. dollars would represent a much smaller bidding increment of just one-tenth of one percent of the security's market value. Accordingly, the portal will allow for the user to specify the bid increment they wish to have applied to each security listed for auction, and to have this be expressed as a percentage of the reserve price selected for the security.

Finally, the interest in a portal for the trading of unique financial instruments may extend to only a limited number of parties for certain classes of specialized products, and as such it may not be economical or practicable to establish a separate trading portal for every instance where a new need arises. Accordingly, to satisfy the need for readily creating trading venues tailored to the particular requirements of a specific class of financial products, the portal can also be used to accommodate trading consortiums of two or more parties. Further, if the parties wish to have their auctions conducted anonymously, this can be accommodated as well.

Within the context then of the above-cited challenges, the present invention succeeds in the following ways:
1. The invention allows for the establishment of an internet portal dedicated to the exchange of complex products, and in so doing provides for a globally-accessible venue for the trading of these unique securities
2. With the trading venue uniquely structured as a portal as defined by the United States Securities and Exchange Commission (http://www.sec.gov/divisions/marketreg/portalsroundtable.htm), no commissions or fees will be charged by the trading venue itself with the sale and purchase of securities.
3. The trading venue will offer a variety of ways that buyers and sellers can communicate prior to a trade being made and without revealing information such as personal or firm telephone numbers or Email addresses.
4. The trading venue will provide for a unique and streamlined manner for uploading multiple documents pertaining to particular trades, and with these documents being readily available online for multiple reviews and downloading.
5. The trading venue will provide for the creation of unique trading consortiums consisting of two or more parties, thus permitting specialized auctions to occur among entities uniquely interested in the consortium's specialization. Further, if it is desired within the consortium to have auctions be conducted anonymously whereby buyers and sellers are unknown to one another throughout the entire auction process, this may be accommodated as well.
6. The trading venue will provide multiple layers of security and assurance inclusive of, though not limited to, username and password protected access to the site, identity confirmation inquiries prior to a user being granted access to the site's buying and selling pages, the site's use of a third-party anti-hacking monitoring service, and the site's use of the United States Postal Service's Electronic Postmark system in conjunction with a third-party Electronic Postmark system which when combined will serve to provide date- and time-stamped records of transmitted documents, as well as ensure anti-tampering controls with Emails and documents contained in those emails, and also protections related to state, federal, and international laws pertaining to the enforceability of electronic signatures and electronic commerce (see the Uniform Electronic Transactions Act (UETA), the Electronic Signatures in Global and National Commerce Act (ESIGN), and the European Union Electronic Signatures Directive).

The ability to effectuate the novelty of the invention's design, and the desirability of the invention's output, are appreciably enhanced by five factors:

First, recent clarity provided by the SEC for what constitutes a portal in the context of financial products;
Second, the timeliness of public and private third-party products available for ensuring data protection and integrity;
Third, the present abundance of complex financial instruments and the concomitant need for greater clarity and opportunity for price discovery in the marketplace;
Fourth, advances in the power and functionality of personal computers, and;
Fifth, the level of confidence and comfort that investors have with performing complex financial transactions via the internet.

The present invention is differentiated from existing financial venues in several ways.

First, the invention provides for a venue whereby no commissions or fees are generated by the venue itself for buyers and sellers using it as a mechanism for trading financial products.
Second, unlike most contemporary financial trading venues, there is no middle-person involved in transactions; trading functions are performed directly by the buyers and sellers themselves.
Third, and related to the second point above, the invention's venue provides for the possibility of communications to be made without buyer and seller having to reveal personal or confidential information related to considerations such as their personal or firm names, Email addresses, or telephone numbers.
Fourth, since by their very nature complex financial products are in a continuous state of evolution and definition, the venue is not defined by particular products as are numerous other trading-oriented websites which hold out that they are specialists in a limited number of instruments as with stocks, bonds, or options. As such the invention's venue is one that is uniquely positioned to grow and evolve in step with market needs as they develop. The present invention does not exclude any type of investment product, and this is an important and fundamental difference to any other trading-oriented internet concern in existence today as of this writing.

### SUMMARY OF THE INVENTION

A computer interface system that pertains to the trading of complex financial instruments within the context of a non-commission, non-fee portal and that includes interface controls to assist in this.

It is an aspect of the present invention that it provides the ability to facilitate communications inclusive of anonymous communications via the internet site where the portal is located, and with a variety of venues inclusive of Email, Instant Messaging, and Teleconferencing.

It is another aspect of the present invention that confirmation of trades that are performed can be completed within the context of complete trade documentation files being included with an Email or facsimile that is automatically generated to a buyer and seller. If a confirmation is performed by Email there is the additional feature of the invention that the Email can be sent in conjunction with the Unites States Postal Service's Electronic Postmark which when used in combination with a third-party Electronic Postmark service will permit the trade confirmation to be sent in a secure and tamper-resistant fashion and with electronic signatures viewed as legally binding by various state, federal, and international protections.

### BRIEF DESCRIPTION OF THE DRAWINGS

FIG. 1 is an illustrative depiction of how a seller may indicate whether they want auction bid increments to be represented in fixed amounts or as a percentage of the reserve price according to the method and apparatus of the present invention.

FIG. 2 shows an illustrative depiction of how a seller may offer a listed auction item as also being available for an immediate purchase according to the method and apparatus of the present invention.

FIG. 3 is a flow diagram of the system logic for the creation of unique trading consortia according to the method and apparatus of the present invention.

FIG. 4 is a flow diagram of the system logic for an automated trade confirmation process according to the method and apparatus of the present invention.

FIG. 5 is a flow diagram of the system logic for anonymous written communications and anonymous verbal communications using either live or recorded venues according to the method and apparatus of the present invention.

FIG. 6 shows an illustrative display of bringing new securities to the marketplace within collaborative framework according to the method and apparatus of the present invention.

### DETAILED DESCRIPTION OF THE INVENTION

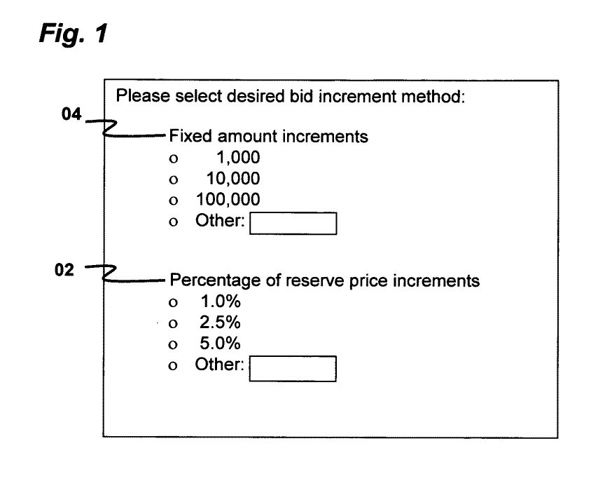

In FIG. 1 the input panel of the interactive display of the incremental bid designation panel of a preferred embodiment is shown. FIG. 1 is where the seller indicates if they want incremental bids to be automatically generated on the basis of a fixed amount or on the basis of a percentage of the auction's reserve price. If a fixed amount is preferred, as can be seen this panel allows the user to select among fixed amount options or to input their own desired fixed amount. For example, if a user inputs 1,000, then incremental bid amounts will automatically be applied in an amount of 1,000. If the seller indicates that they want incremental bids to be automatically generated on the basis of a percentage of the auction's reserve price, as can be seen the panel also allow the user to select among percentage options or to input their own desired percentage. For example, if the reserve price is 1,000,000 and the incremental bid percentage is selected to be 2.5%, then incremental bids will automatically be generated at 25,000.

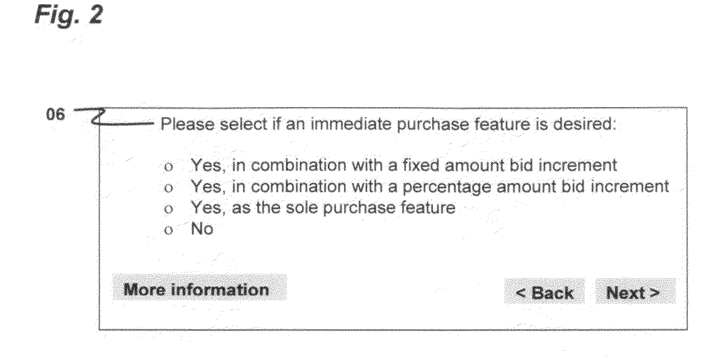

In FIG. 2 the input panel of the interactive display of the immediate purchase designation panel of a preferred embodiment is shown. FIG. 2 is where the seller indicates if they wish to list an auction as being by bid only, by immediate purchase only, or a combination of the two. If an immediate purchase designation is selected the user must also indicate what the immediate purchase price is to be.

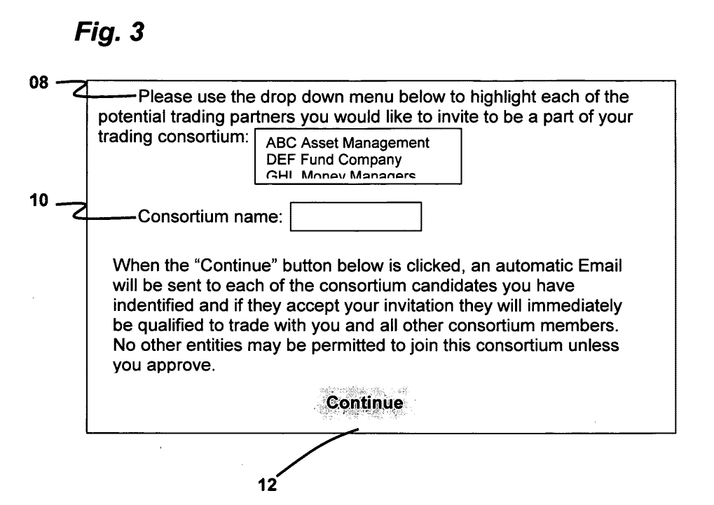

In FIG. 3 the input panel of the interactive display of the creation of trading consortium of a preferred embodiment is shown. For example, if a particular subset of users desire to have multiple auctions among one another to the exclusion of other users, or if a subset of users desire to have a single private auction limited to pre-determined entities, these unique trading consortia may be created. FIG. 3 shows how trading consortium members can be identified, along with creating a particular consortium name.

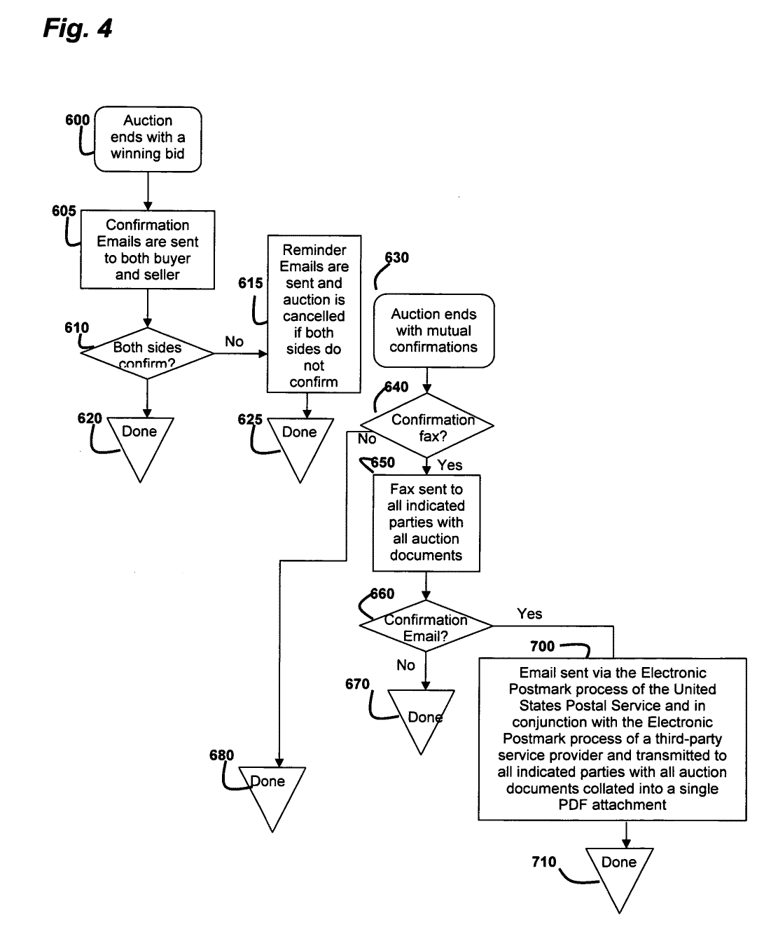

In FIG. 4 a flow diagram is shown depicting the system logic for an automated trade confirmation process inclusive of the system logic for an automated document collation inclusive of electronic postmark and Email and facsimile capabilities according to the method and apparatus of the present invention.

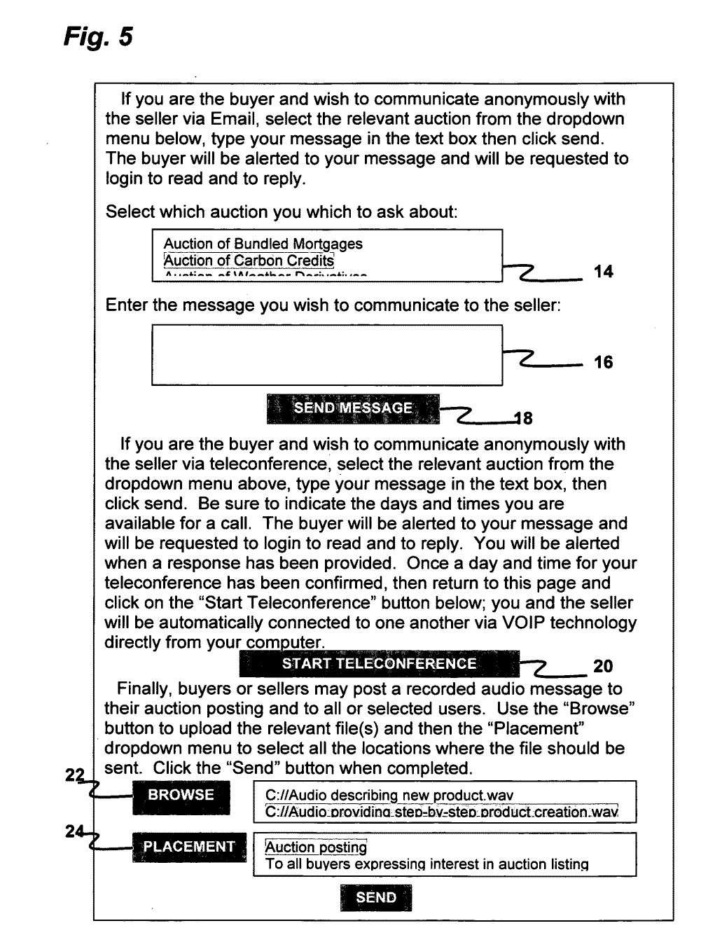

FIG. 5 is a flow diagram of the system logic for anonymous written or verbal communications and with the latter using either live or recorded venues. FIG. 5 shows how these anonymous communications may be created in a logical manner by the user.

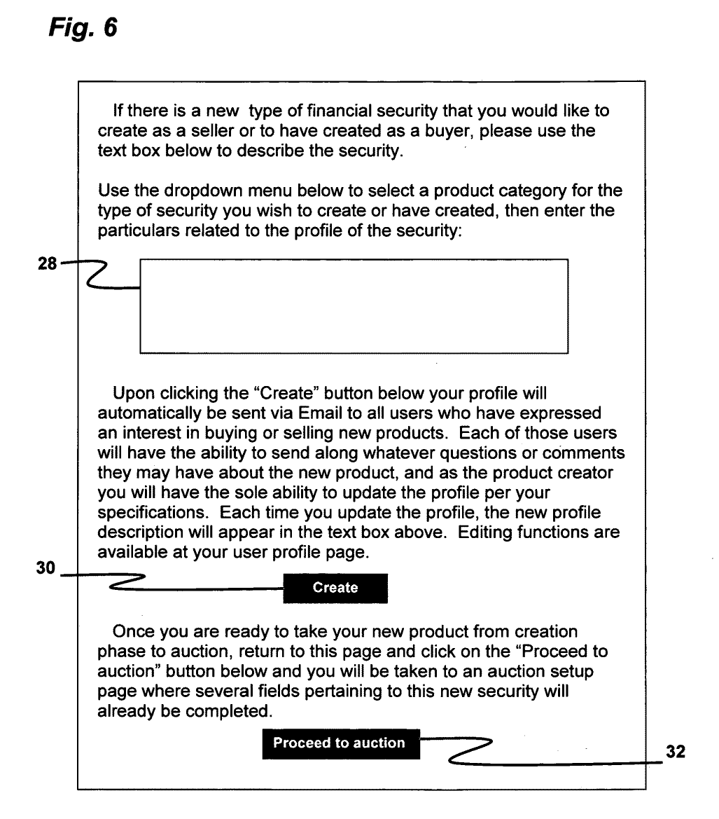

FIG. 6 shows an illustrative display of bringing new securities to the marketplace within collaborative framework. FIG. 6 shows how the process can work with the initial description of the new security through to the auctioning of that security.

Other applications of the present invention could include the application of anonymous communications, written or verbal, for a variety of other interne venues, the application of having all documents associated with a particular transaction being collated into a single bundled document, and the application of having an automated sending of single bundled documents via Email and in a secure encrypted fashion within the framework described herein.

We claim:

1. A computer method and apparatus that facilities the trading of non-listed and over-the-counter complex financial instruments on the interne within the context of a portal as defined by the United States Securities and Exchange Commission as at http://www.sec.gov/divisions/marketreg/portalsroundtable.htm.

2. The system according to claim 1 wherein a live auction is a mechanism whereby the complex financial instruments may be purchased and sold.

3. The system of claim 2 further comprising the step of the seller specifying the incremental bids that are to be applied for the bidding process of each listed security.

4. The system of claim 3 further comprising the step of the incremental bid being specified as a percentage of the seller's reserve price for the security being listed.

5. The system according to claim 1 wherein a feature to make an immediate purchase of a complex financial product is another mechanism whereby the complex financial instruments may be purchased and sold.

6. The system according to claim 1 wherein auction participants are limited exclusively to qualified institutional investors as defined by defined by the United States Securities and Exchange Commission in Rule 144A under the Securities Act of 1933.

7. The system according to claim 1 wherein the ability exists to have anonymous communications via Email where messages are sent to and from a dedicated Email facility located at the interne site where the portal is located.

8. The system according to claim 1 wherein the ability exists to have anonymous communications via Instant Messaging capabilities available from a dedicated Instant Messaging facility located at the interne site where the portal is located.

9. The system according to claim 1 wherein the ability exists to have anonymous communications by teleconference where calls by two or more parties are placed to a telephone number provided at the portal and where once connected parties can exchange information without having to state who they are or where they are calling from.

10. The system of claim 9 further comprising the step of having anonymous communications by teleconference and effectuated via a third-party voice over interne protocol or VOIP directly from the portal and such that any parties calling into the telephone number provided at the portal may do so from their own laptop computer, desktop computer, or any other device that permits accessing the internet.

11. The system according to claim 1 wherein a confirmation of an agreed transaction between buyer and seller is automatically generated and sent via Email to the buyer and seller and any other party designated by the buyer or seller.

12. The system of claim 11 further comprising the step of having all documents accompany an agreed transaction inclusive of documents prepared by word processing software or spreadsheet software or documents with extensions of .doc, .csv, .txt, .pdf, .tif, .peg, or any other related contexts.

13. The system of claim 11 further comprising the step of having the Email sent via the Electronic Postmark process of the United States Postal Service and in conjunction with the Electronic Postmark process of a third-party service provider such that the combination of these processes provides an Email with anti-tampering protections as well as a mechanism for establishing the basis for electronic signatures having been provided.

14. The system according to claim 1 wherein an electronic facsimile of the confirmation of an agreed transaction between buyer and seller is automatically generated directly from the portal to the buyer and seller and any other party designated by the buyer or seller.

15. The system of claim 14 further comprising the step of having all documents accompanying a particular trade inclusive of documents prepared by word processing software or spreadsheet software or documents with extensions of .doc, .csv, .txt, .pdf, .tif, .peg, or any other related contexts.

16. The system according to claim 1, wherein specialized trading consortiums can be created for two or more parties interested in focusing on a particular class or subset of financial instruments.

17. The system according to claim 16, wherein the trading consortiums can be created where every participating member of the consortium can perform trades among one another anonymously.

18. The system according to claim 1, wherein the portal may also be used as a venue for bringing new issues to the marketplace.
